(19) United States
(12) Patent Application Publication
(10) Pub. No.: US 2012/0146771 A1
(43) Pub. Date: Jun. 14, 2012

(54) RADIO COMMUNICATION APPARATUS AND RADIO COMMUNICATION METHOD

(75) Inventor: Takahiro Shimura, Gotemba-shi (JP)

(73) Assignee: TOSHIBA TEC KABUSHIKI KAISHA, Tokyo (JP)

(21) Appl. No.: 13/305,846

(22) Filed: Nov. 29, 2011

(30) Foreign Application Priority Data
Dec. 10, 2010 (JP) 2010-275870

(51) Int. Cl. G06K 7/01

(52) U.S. Cl. 340/10.4

(57) ABSTRACT

According to one embodiment, a radio communication apparatus includes a transmitting and receiving section, a preamble detecting section, a data detecting section, and a response-time setting section. The transmitting and receiving section transmits an inquiry signal to a radio tag and receives a response signal returned from the radio tag. The preamble detecting section detects, within a period set with reference to transmission timing of the inquiry signal, a preamble included in the response signal returned by the radio tag that receives the inquiry signal. The data detecting section detects, when the preamble is detected, data included in the response signal. The response-time setting section sets, according to a parameter peculiar to the apparatus, a response time from the reception of the response signal from the radio tag until the transmission of the next inquiry signal to the radio tag by the transmitting and receiving section.

### CROSS-REFERENCE TO RELATED APPLICATIONS

This application is based upon and claims the benefit of priority from the prior Japanese Patent Application No. 2010-275870, filed on Dec. 10, 2010, the entire contents of which are incorporated herein by reference.

### FIELD

Embodiments described herein relate generally to a radio communication apparatus and a radio communication method for transmitting an inquiry signal to a radio tag and receiving a response signal.

### BACKGROUND

A radio communication apparatus is developed and put to practical use that includes an antenna and performs radio communication with a radio tag present in a communication area of the antenna using a radio wave, thereby being capable of reading out data from a memory mounted on the radio tag and writing data in the memory. Such a radio tag is referred to as RFID (Radio Frequency Identification) tag or the like. The radio communication apparatus is referred to as RFID reader or the like.

As an example of the radio communication apparatus, there is known a radio communication apparatus configured to transmit a carrier wave of a predetermined frequency to a radio tag to start the radio tag, transmit an inquiry signal to the started radio tag, and receive a response signal from the radio tag to read the radio tag. The radio tag that communicates with the radio communication apparatus of this type returns, according to so-called backscatter modulation, a response signal of a frequency same as the frequency of the carrier wave from the radio communication apparatus.

The radio tag and the radio communication apparatus having such functions are used in various fields such as goods management in the physical distribution industry. In recent years, there is also an example in which a store that sells various commodities introduces a commodity sale system configured to attach radio tags to the commodities in the store and read the radio tags attached to the commodities during settlement in a register to enable settlement processing to be performed.

In a system in which plural radio communication apparatuses are arranged, a radio tag that should originally be read by only one radio communication apparatus could be inadvertently simultaneously read by the plural radio communication apparatuses.

In such a case, a problem occurs because each of the radio communication apparatuses performs processing using information read from the radio tag. For example, in the commodity sales system, if a radio tag attached to a commodity carried to a certain register is read by not only a radio communication apparatus arranged in the register but also a radio communication apparatus in a register adjacent to the register, it is not unlikely that one commodity is subjected to sales processing in both the registers.

Under such circumstances, when plural radio communication apparatuses are arranged close to one another and used, it is necessary to take measures for preventing the plural radio communication apparatuses from simultaneously reading the same radio tag.

### BRIEF DESCRIPTION OF THE DRAWINGS

FIG. 1 is a diagram for explaining a command sequence of radio tag reading in C1G2 (Class 1 Generation 2);

FIG. 2 is a block diagram of a main part configuration of a reader in an embodiment;

FIG. 3 is a block diagram for explaining detection of a preamble in the embodiment;

FIG. 4 is a diagram for explaining a response time in C1G2;

FIG. 5 is a diagram of a preamble affixed to the head of a Query command in C1G2;

FIG. 6 is a diagram for explaining a relation between FT (Frequency Tolerance) and other parameters in C1G2;

FIG. 7 is a diagram for explaining a comparison start time Ts and a comparison end time Te in the embodiment;

FIG. 8 is a schematic diagram of a data structure of a conversion table in the embodiment;

FIG. 9 is a diagram of an example of the conversion table in the embodiment;

FIG. 10 is a flowchart for explaining the operation of a response-time setting section in the embodiment;

FIG. 11 is a diagram for explaining action in the embodiment;

FIG. 12 is a diagram for explaining action in the embodiment;

FIG. 13 is a diagram of a communication sequence in a state shown in FIG. 11; and

FIG. 14 is a diagram of a communication sequence in a state shown in FIG. 12.

### DETAILED DESCRIPTION

In general, according to one embodiment, a radio communication apparatus includes a transmitting and receiving section, a preamble detecting section, a data detecting section, and a response-time setting section.

The transmitting and receiving section transmits an inquiry signal to a radio tag and receives a response signal returned from the radio tag. The preamble detecting section detects, within a period set with reference to transmission timing of the inquiry signal transmitted by the transmitting and receiving section, a preamble included in the response signal returned by the radio tag that receives the inquiry signal. The data detecting section detects, when the preamble detecting section detects the preamble included in the response signal, data following the preamble included in the response signal. The response-time setting section sets, according to a parameter peculiar to the apparatus, a response time from the reception of the response signal from the radio tag until transmission of the next inquiry signal to the radio tag by the transmitting and receiving section.

An embodiment is explained below.

In the embodiment explained below, a radio communication apparatus is illustrated that communicates with a radio tag using a communication protocol of a C1G2 (Class 1 Generation 2) type that is a standard protocol of UHF band (950 MHz band) RFID proposed by the EPC (Electronic Product Code) global, the standardization organization for RFID tags.

### Communication in C1G2

First, communication in C1G2 is schematically explained.

In C1G2, reading of a radio tag is realized by a command sequence called Inventory Tags. The Inventory Tags include a Select command for performing selection of a communication tag, Query, Query Rep, and Query Adjust commands for performing anti collision (collision prevention) processing, and an ACK command for acquiring (requesting) tag data after the anti collision processing. These commands are combined to realize a command sequence for acquiring tag data.

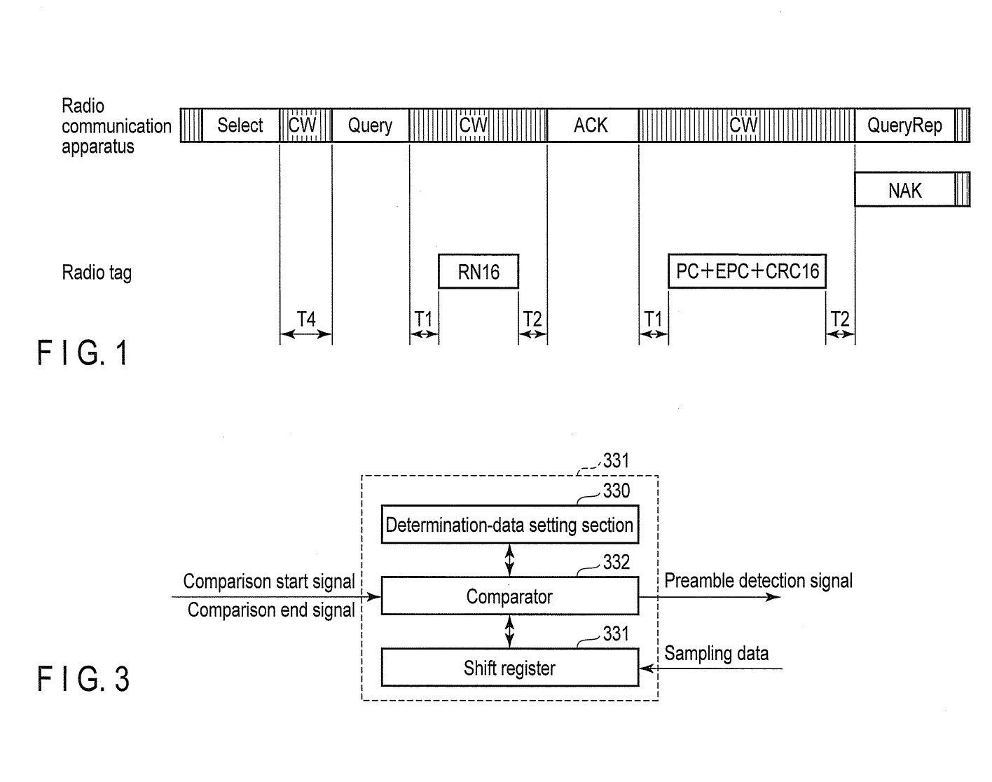

A state of acquisition of tag data by the command sequence of the Inventory Tags is shown in FIG. 1. The tag data to be acquired is called EPC code. The radio communication apparatus transmits an unmodulated carrier (CW: continuous wave) from an antenna. The radio tag receives the unmodulated carrier and starts. After the radio tag starts, if the radio communication apparatus designates a radio tag with which the radio communication apparatus communicates, the radio communication apparatus transmits a Select command. However, in this embodiment, the Select command is not used.

First, the radio communication apparatus transmits a Query command. If the radio tag receives the Query command, the radio tag subjects the unmodulated carrier to backscatter modulation and returns a random number called RN16 when a response time T1 set in advance elapses from the completion of the reception of the command.

The radio communication apparatus that receives the RN16 transmits an ACK command with RN16 set as an argument after a response time T2 elapses from the completion of the reception of the RN16. If the RN16 transmitted by the radio tag and the RN16 of the ACK command coincide with each other, the radio tag that receives the ACK command subjects the unmodulated carrier to the backscatter modulation and returns header information indicating the length of data called PC (Protocol Control), an EPC code, and CRC16 (Cyclic Redundancy Check 16) for communication error detection when the response time T1 elapses from the completion of the reception of the ACK command.

If the radio communication apparatus receives the PC+EPC+CRC16 returned in this way and a result of CRC check is normal, the radio communication apparatus transmits a Query Rep command when the response time T2 elapses from the completion of the reception of the PC+EPC+CRC16.

On the other hand, if the EPC code cannot be normally acquired, for example, if the result of the CRC check is abnormal, the radio communication apparatus transmits a NAK command when the response time T2 elapses from the completion of the reception of the PC+EPC+CRC16.

### Reader

A reader 1 functioning as the radio communication apparatus (or an interrogator) in this embodiment is explained. The reader 1 and a radio tag read by the reader 1 communicate with each other according to a command sequence of C1G2.

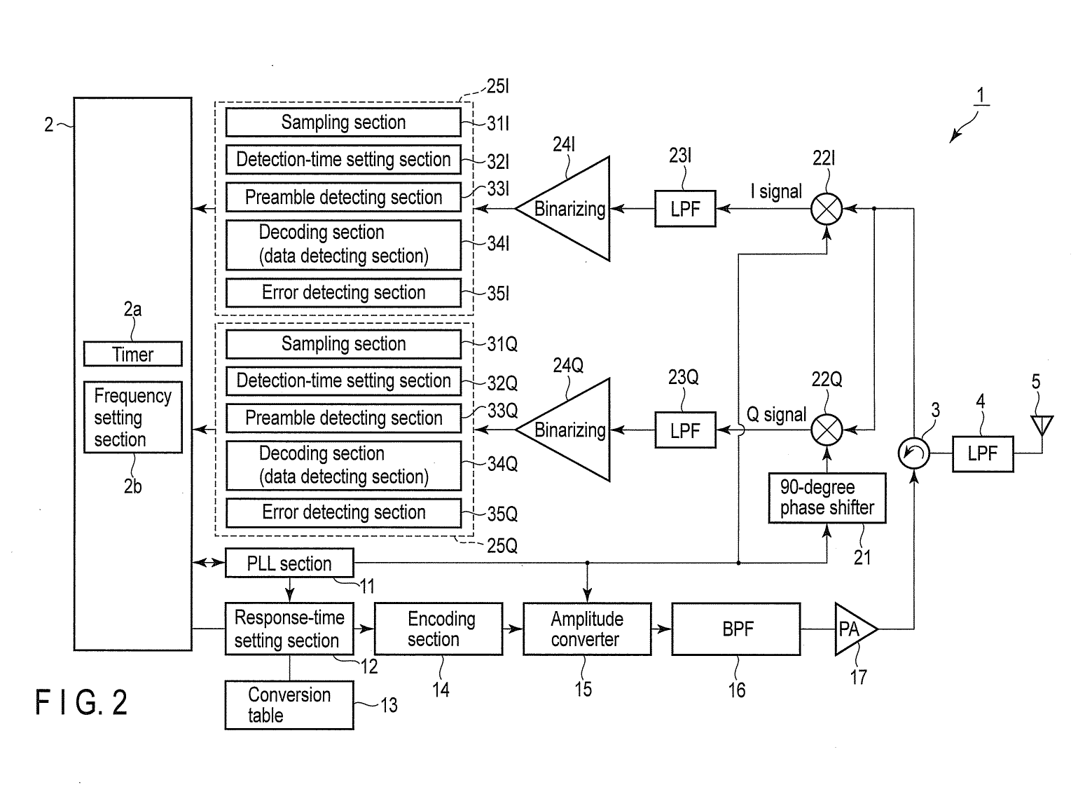

FIG. 2 is a block diagram of a main part configuration of the reader 1. The reader 1 includes a controller 2 including a CPU (Central Processing Unit), a memory, and a timer 2a, a directional coupler 3, a low-pass filter (LPF) 4, an antenna 5, a transmission system circuit used for transmission of a command (an inquiry signal) and an unmodulated carrier to the radio tag, and a reception system circuit used for reception of a response signal from the radio tag. The transmitting and receiving section according to this embodiment is configured by a part or all of the transmission system circuit and the reception system circuit.

The controller 2 includes a frequency setting section 2b realized by, for example, information processing performed using software. The frequency setting section 2b sets, on the basis of information input by operation of not-shown operation means or information input from a host apparatus, a frequency channel used by the reader 1 in the communication with the radio tag. The frequency channel of the reader 1 is set to a frequency channel different from frequency channels used by other radio communication apparatuses and the like operating around the reader 1.

The transmission system circuit includes a PLL (Phase Locked Loop) section 11 that outputs a local carrier signal of a frequency set by the frequency setting section 2b, a response-time setting section 12, a conversion table 13, an encoding section 14 that performs encoding of a transmission signal output from the controller 2 through the response-time setting section 12, an amplitude modulator 15 that performs amplitude modulation for the encoded transmission signal, a band-pass filter (BPF) 16 that removes an unnecessary component from the modulated transmission signal, and a power amplifier (PA) 17 that amplifies the transmission signal passed through the band-pass filter 16 and supplies the transmission signal to the directional coupler 3.

If transmission system circuit transmits an unmodulated carrier to the radio tag, the encoding section 14 encodes, at a high level, a local carrier signal output from the PLL section 11. The amplitude modulator 15 modulates the amplitude of the local carrier signal to a maximum level. After the band-pass filter 16 removes an unnecessary component of the local carrier signal, the power amplifier 17 amplifies the local carrier signal. An output of the power amplifier 17 is supplied to the low-pass filter 4 via the directional coupler 3. After an unnecessary high-frequency component is removed, the output is supplied to the antenna 5 and transmitted as the unmodulated carrier.

If the transmission system circuit transmits a command such as Query or ACK to the radio tag, the controller 2 outputs bit data of the command in a state in which a local carrier signal is output from the PLL section 11. The encoding section 14 encodes the bit data with FM0 encoding. The amplitude modulator 15 amplifies a signal after the encoding to predetermined amplitude. After the band-pass filter 16 removes an unnecessary component, the power amplifier 17 amplifies the signal. An output of the power amplifier 17 is supplied to the low-pass filter 4 via the directional coupler 3. After an unnecessary high-frequency component is removed, the output is supplied to the antenna 5 and transmitted as the command. The FM0 encoding is a system for reversing a level from “H” (high) to “L” (low) or from “L” to “H” in the center of one bit to represent “0”, keeping and not changing the level in one bit to represent “1”, and reversing the level to switch a certain bit to the next bit. However, another encoding system such as Manchester encoding may be adopted instead of the FM0 encoding.

The response-time setting section 12 sets the response time T2 using parameters peculiar to the reader 1. Details of the setting are explained later.

The reception system circuit includes a 90-degree phase shifter 21 that shifts a phase of a local carrier signal from the PLL section 11 by 90 degrees, mixers 22 (22I and 22Q), low-pass filters 23 (23I and 23Q), binarizing circuits 24 (24I and 24Q), and signal processing sections 25 (25I and 25Q). The reception system circuit performs reception processing in a direct conversion system for directly removing a carrier component. The signal processing sections 25 include sampling sections 31 (31I and 31Q), detection-time setting sections 32 (32I and 32Q), preamble detecting sections 33 (33I and 33Q), decoding sections 34 (34I and 34Q), and error detecting sections 35 (35I and 35Q). The decoding sections 34 function as the data detecting section according to this embodiment.

The local carrier signal from the PLL section 11 is directly supplied to the mixer 22I. The local carrier signal after the phase is shifted by 90 degrees by the 90-degree phase shifter 21 is supplied to the mixer 22Q.

Reception processing by the reception system circuit is explained. If the radio tag receives a command transmitted by the transmission system circuit, the radio tag subjects the unmodulated carrier to the backscatter modulation to thereby return a response signal encoded by the FM0 encoding. If the response signal is received by the antenna 5, the antenna 5 outputs a reception signal corresponding to the response signal. The reception signal is supplied to the low-pass filter 4. After an unnecessary high-frequency component included in the signal is removed, the reception signal is supplied to the mixers 22I and 22Q via the directional coupler 3.

The mixer 22I mixes the local carrier signal supplied from the PLL section 11 and the reception signal supplied from the directional coupler 3 and generates an I signal having a component with the same phase as the local carrier signal. The I signal is supplied to the low-pass filter 23I. After an unnecessary high-frequency component is removed, the I signal is binarized by the binarizing circuit 24I and supplied to the signal processing section 25I.

On the other hand, the mixer 22Q mixes the local carrier signal supplied from the 90-degree phase shifter 21 and the reception signal supplied from the directional coupler 3 and generates a Q signal having a component orthogonal to the local carrier signal. The Q signal is supplied to the low-pass filter 23Q. After an unnecessary high-frequency component is removed, the Q signal is binarized by the binarizing circuit 24Q and supplied to the signal processing section 25Q.

The sampling section 31I samples the reception signal with a clock synchronizing with the I signal supplied from the binarizing circuit 24I and generates bit data. A period At based on transmission timing of an immediately preceding transmitted command is set in the detection-time setting section 32I.

The preamble detecting section 33I detects a preamble affixed to the head of the response signal, which is received from the radio tag, from the bit data generated by the sampling section 31I within a range of the period Δt set in the detection-time setting section 32I.

The decoding section 34I decodes, with the FM0 coding, a portion following the preamble of the bit data generated by the sampling section 31I according to the detection of the preamble by the preamble detecting section 33I, generates final digital data indicating the response signal from the radio tag, and outputs the digital data to the controller 2 and the error detecting section 35I. In the decoding, if continuous bit data is “0, 0” and “1, 1”, the bit data is decoded as data “1”. If continuous bit data is “1, 0” and “0, 1”, the bit data is decoded as data “0”. If the preamble is not detected by the preamble detecting section 33I, the error detecting section 35I notifies the controller 2 of a preamble detection error.

The detection of the preamble by the preamble detecting section 33I is explained with reference to a block diagram of FIG. 3. The preamble detecting section 33I includes a determination-data setting section 330 that stores preamble patterns set in C1G2, a shift register 331 that sequentially stores bit data sampled by the sampling section 31I, and a comparator 332 that compares the preamble patterns stored in the determination-data setting section 330 and the bit data stored in the shift register 331. A comparison start time Ts and a comparison end time Te are stored in the detection-time setting section 32I. The comparison start time Ts is a time from the output of a last bit of a command such as Query or ACK from the controller 2 to the transmission system circuit until the start of comparison by the comparator 332. The comparison end time Te is a time from the output of the last bit of the command such as Query or ACK from the controller 2 to the transmission system circuit until the end of the comparison by the comparator 332. In other words, a difference between the comparison end time Te and the comparison start time Ts is the period Δt.

After outputting the last bit of the command such as Query or ACK to the transmission system circuit, the controller 2 starts time measurement by the timer 2a. When measured time of the timer 2a reaches the comparison start time Ts set in the detection-time setting section 32I, the controller 2 outputs a comparison start signal to the comparator 332. Thereafter, when the measured time of the timer 2a reaches the comparison end time Te set in the detection-time setting section 32I, the controller 2 outputs a comparison end signal to the comparator 332. For example, according to the input of the comparison start signal, the comparator 332 starts comparison of the preamble patterns stored in the determination-data setting section 330 and the same number of bit data as the preamble patterns from the head of the bit data stored in the shift register 331. According to the input of a comparison end signal, the comparator 332 ends the comparison. When the comparator 332 detects a pattern, a preamble of which coincides with the preamble patterns stored in the determination-data setting section 330, the comparator 332 outputs a preamble detection signal to the decoding section 34I. According to the input of the preamble detection signal, the decoding section 34I decodes bit data following the preamble as explained above. The decoded bit data is output to the controller 2.

On the other hand, when the preamble is not detected at a point when the comparison end time Te elapses, the error detecting section 35I notifies the controller 2 of a preamble detection error as explained above.

Processing by the signal processing section 25Q performed using the Q signal is the same as the processing by the signal processing section 25I performed using the I signal. Therefore, explanation of the processing is omitted. The controller 2 performs processing for, for example, outputting more accurate one of the data output from the signal processing sections 25I and 25Q to a not-shown host apparatus.

### Response Times T1 and T2

The response times T1 and T2 are explained.

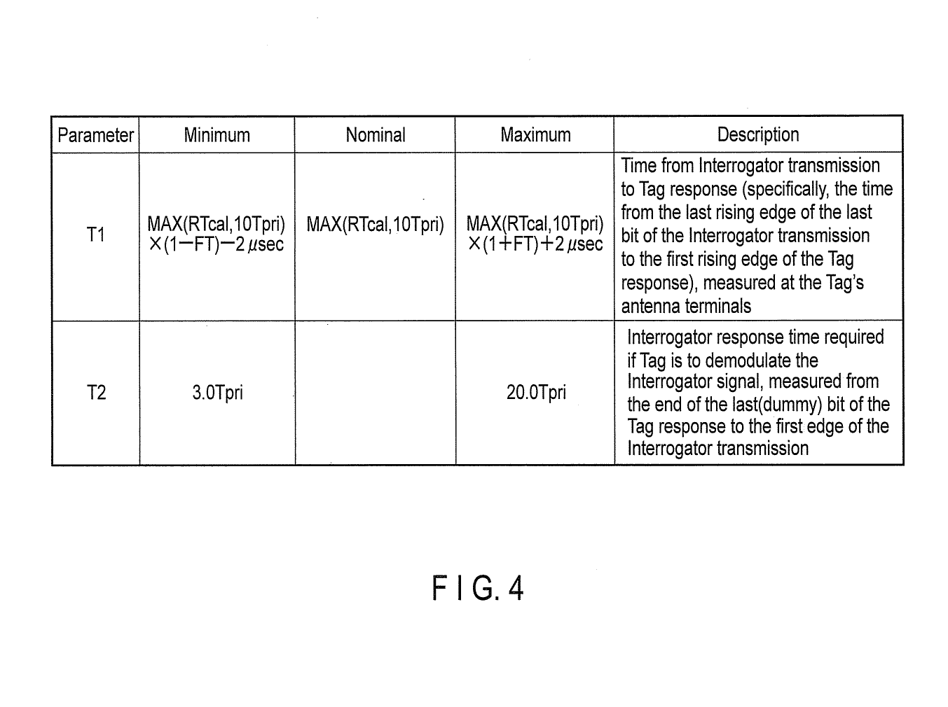

In C1G2, the response times T1 and T2 are set as shown in FIG. 4.

The response time T1 is a time from the reception of a command from the reader 1 and the return of a response signal by the radio tag as explained above. Specifically, the response time T1 is a time from the rising edge of the last bit of the command during the command reception until the rising edge of the first bit during the return of the response signal to the command. A value of the response time T1 is set within a range indicated by Expression (1) below.

T1 min≦T1≦T1 max (1)

A minimum T1 min and a maximum T1 max of the response time T1 are set by Expressions (2) and (3) below.

T1 min=MAX(RT cal, 10T pri)×(1−FT)−2 μsec (2)

T1 max=MAX(RT cal, 10T pri)×(1+FT)+2 μsec (3)

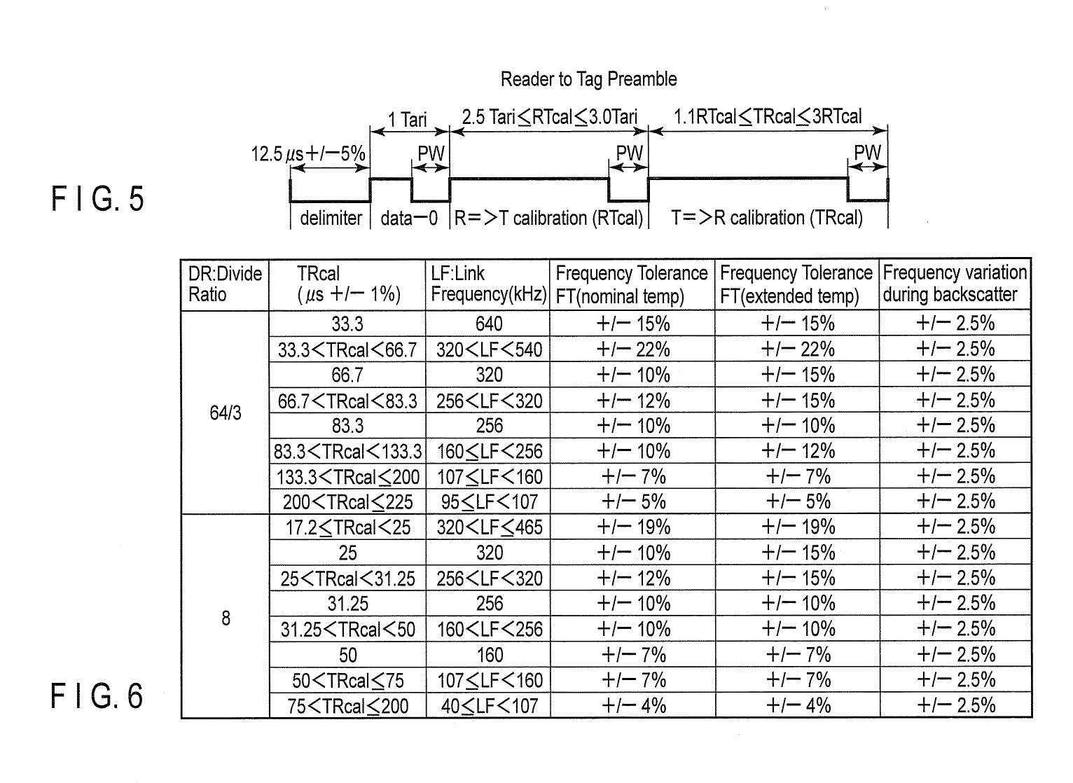

RT cal (Interrogator-to-Tag calibration symbol), T pri (Backscatter-link pulse-repetition interval), and LF (Link Frequency) are parameters set in a communication protocol of a C1G2 type. Specifically, the RT cal is a value for determining communication speed from the radio tag to the reader 1 and is defined in a preamble affixed to the head of a Query command as shown in FIG. 5. The preamble shown in the figure includes bit data indicating a delimiter that is a break of a command and a command, bit data for indicating a time interval T an (Type A reference interval) of a data symbol “0”, bit data indicating the RT cal, which is a value for determining communication speed from the radio tag to the reader 1, and bit data indicating TR cal (Tag-to-Interrogator calibration symbol), which is a value for determining communication speed from the radio tag to the reader 1. The FT is fluctuation (frequency tolerance) of the backscatter modulation of the radio tag and is determined on the basis of a correspondence relation shown in FIG. 6 specified by the communication protocol of the C1G2 type. In a table shown in the figure, a correspondence relation among a divide ratio (DR), the TR cal, a response frequency LF (Link Frequency) of the radio tag, the frequency tolerance FT at rated temperature (normal temperature), the frequency tolerance FT at extended temperature, and frequency variation during the backscatter modulation is defined. The division ratio DR is a ratio of the TR cal and a response period T pri indicating a response time of 1 bit (DR=TR cal/T pri) and set to “64/3” or “8”. The response frequency LF is an inverse of the response period T pri (LF=1/T pri). Usually, the FT at the rated temperature only has to be used for the calculation of Expressions (2) and (3).

In this embodiment, it is assumed that the RT cal and the T pri are set as fixed values in advance. In other words, values of the T1 min and the T1 max represented by Expressions (2) and (3) are known. Comparison start time Ts and comparison end time Te

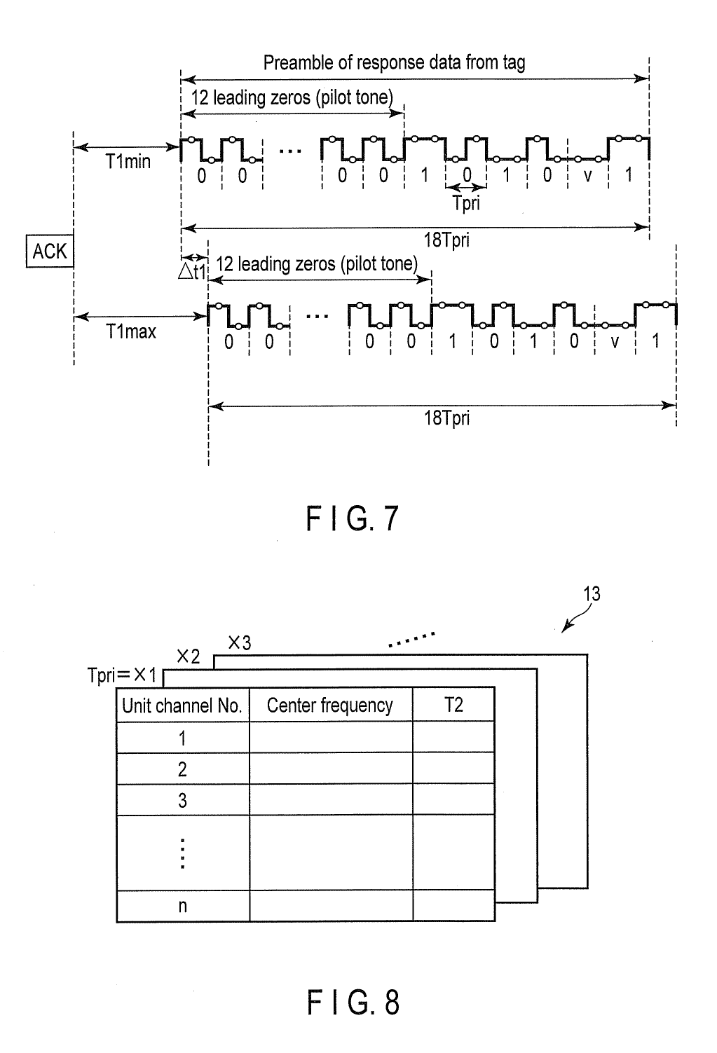

The comparison start time Ts and the comparison end time Te are explained with reference to FIG. 7.

In this embodiment, the preamble affixed to the head of the response signal from the radio tag is represented by eighteen symbols of “0000000000001010V1”. The higher-order twelve “0” indicate a pilot tone. “1010V1” following the pilot tone is bit data for preamble detection. “V” is a bit not conforming to a rule of the FM0 encoding and is used only in the preamble. If the preamble is encoded by the FM0 encoding, bit data “101010101010101010101010110100100011” is obtained. In the bit data, “110100100011” equivalent to the bit data for preamble detection is stored in the determination-data setting section 330. In the sampling sections 31I and 31Q, binarized I signal and Q signal are respectively sampled with 0.5 T pri. Bit data are generated and sequentially stored respectively in the shift registers 331 of the preamble detecting sections 33I and 33Q.

In this case, if the radio tag returns a response signal in the shortest response time T1 within the range of Expression (1), i.e., the T1 min, after the last bit of a command for requesting the response signal is output to the transmission system circuit, a preamble of the response signal starts to be stored in the shift registers 331 of the preamble detecting sections 33I and 33Q when the response time T1 min elapses. Thereafter, at a point when 18×T pri elapses, the storage of the bit data of the preamble in the shift registers 331 is completed. If the radio tag returns a response signal in the longest response time T1 within the range of Expression (1), i.e., the T1 max, after the last bit of a command for requesting the response signal is output to the transmission system circuit, a preamble of the response signal starts to be stored in the shift registers 331 of the preamble detecting sections 33I and 33Q when the response time T1 max elapses. Thereafter, at a point when 18×T pri elapses, the storage of the bit data of the preamble in the shift registers 331 is completed.

Specifically, if the response time T1 fluctuates within the range of Expression (1), in order to surely detect a preamble of a response signal from the radio tag, the comparison start time Ts and the comparison end time Te have to be set to values indicated by Expressions (4) and (5) below.

Ts=T1 min+18×T pri (4)

Te=T1 max+18×T pri (5)

According to Expressions (4) and (5), a difference between the comparison end time Te and the comparison start time Ts, i.e., the period Δt for comparing preambles is represented by Expression (6) below.

Δt=T1 max−T1 min (6)

The period Δt indicated by Expression (6) is used for setting the response time T2. Details of the setting are explained later.

### Setting of the Response Time T2

The setting of the response time T2 performed by the response-time setting section 12 is explained. In an example explained in this embodiment, a frequency channel set by the frequency setting section 2b is used as a parameter peculiar to the reader 1.

The response time T2 is set within a range of Expression (7) below.

T2 min≦T2≦T2 max (7)

As it is seen from FIG. 4, a minimum T2 min and a maximum T2 max of the response time T2 in C1G2 are represented by Expressions (8) and (9) below.

T2 min=3×T pri (8)

T2 max=20×T pri (9)

The response time T2 is set within a range indicated by Expressions (7) to (9).

The response-time setting section 12 in this embodiment changes the response time T2 according to a frequency set by the frequency setting section 2b.

A correspondence relation between the frequency set by the frequency setting section 2b and the response time T2 that should be set by the response-time setting section 12 is described in the conversion table 13. FIG. 8 is a schematic diagram of a data structure of the conversion table 13. As it is seen from Expressions (7) to (9), the tolerance of the response time T2 changes according to a value of the response period T pri. Therefore, in this embodiment, the conversion table 13 is prepared for each value of the response period T pri. Consequently, even if the response period T pri is changed, it is possible to select the response time T2 not to deviate from the tolerance set in C1G2.

In conversion tables 13, for each of frequency channels (No. 1 to n) set by the frequency setting section 2b, a center frequency and the response time T2 of the channel are described. The center frequency is a reference value of a frequency used in each of the frequency channels. As the response time T2, values not overlapping in the conversion tables 13 are described within a range in which Expressions (7) to (9) are satisfied.

A difference between each of response times T2 described in each of the conversion tables 13 and another response time T2 described in the same table (hereinafter referred to as discrete interval) is set at least larger than the period Δt indicated by Expression (6) (discrete interval>Δt).

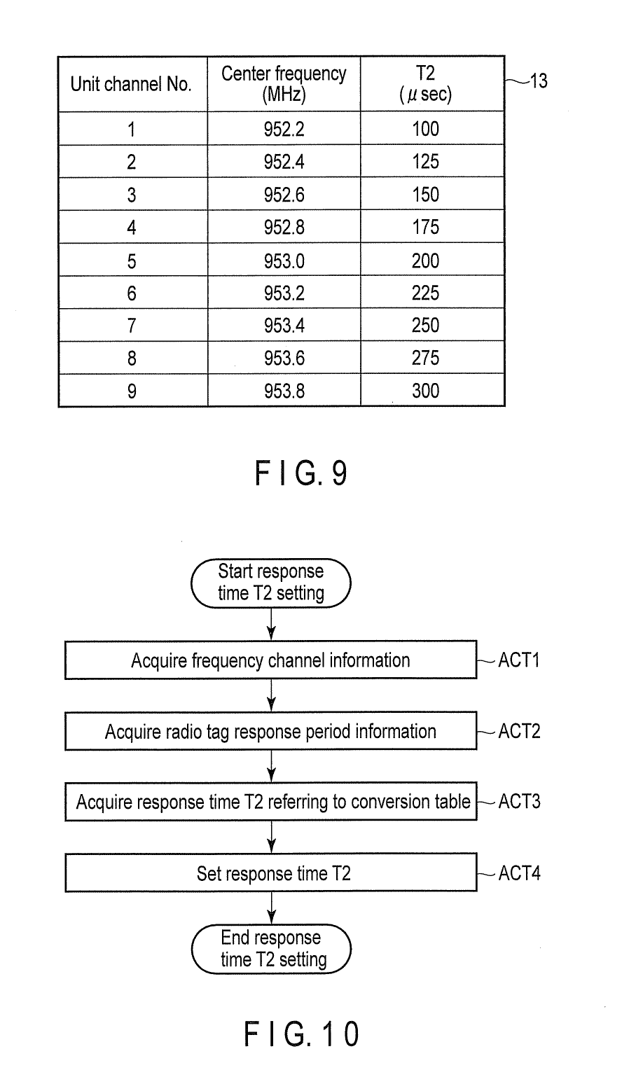

An example of the conversion table 13 in which specific numerical values are described is shown in FIG. 9. The conversion table 13 is an example in which RT cal=75 μsec, the response period T pri of the radio tag=25 μsec, and nine channels in total defined at an interval of 0.2 MHz between frequencies 952.2 MHz and 953.8 MHz in a UHF band are prepared as frequency channels used by the reader 1. In this case, the tolerance of the response time T2 is 75 μsec to 500 μsec from Expressions (7) to (9) and the period Δt is 24 μsec from Expression (6). Taking this into account, the response times T2 corresponding to the frequency channels are set within the range of 75 μsec to 500 μsec with the discrete interval set as 25 μsec larger than 24 μsec.

The operation of the response-time setting section 12 is explained.

The response-time setting section 12 operates according to a flowchart of FIG. 10 and sets the response time T2. The operation is started when, for example, a frequency used for communication by the reader 1 is changed by the frequency setting section 2b.

In the beginning when setting processing for the response time T2 is started, first, the response-time setting section 12 accesses the memory of the controller 2 and acquires information indicating a frequency channel set by the frequency setting section 2b (ACT 1). Further, the response-time setting section 12 accesses the memory of the controller 2 and acquires information indicating the response period T pri currently used by the reader 1 (ACT 2).

Subsequently, the response-time setting section 12 acquires, referring to the conversion table 13 corresponding to the response period T pri indicated by the information acquired in ACT 2, the response time T2 associated with the frequency channel acquired in ACT 1 (ACT 3).

The response-time setting section 12 sets the response time T2 acquired in ACT 3 as the response time T2 used in subsequent communication (ACT 4). Specifically, the response-time setting section 12 stores the response time T2 acquired in ACT 3 in a storage area for setting of the response time T2 provided in the memory of the controller 2.

After ACT 4, a series of processing related to the setting of the response time T2 ends. After the series of processing is performed, the controller 2 performs communication with the radio tag using the response time T2 set in ACT 4. Specifically, when the controller 2 receives the last bit of the RN16 or the PC+EPC+CRC16 from the radio tag, after measuring the set response time T2 with the timer 2a, the controller 2 outputs the first bit of a command such as ACK or Query Rep to the transmission system circuit.

In this way, the response-time setting section 12 selects one time width corresponding to a frequency channel currently used by the reader 1 out of plural time widths described in the conversion table 13 and sets the selected time width as the response time T2 used subsequent communication.

### Action

Action of the configuration explained above is explained.

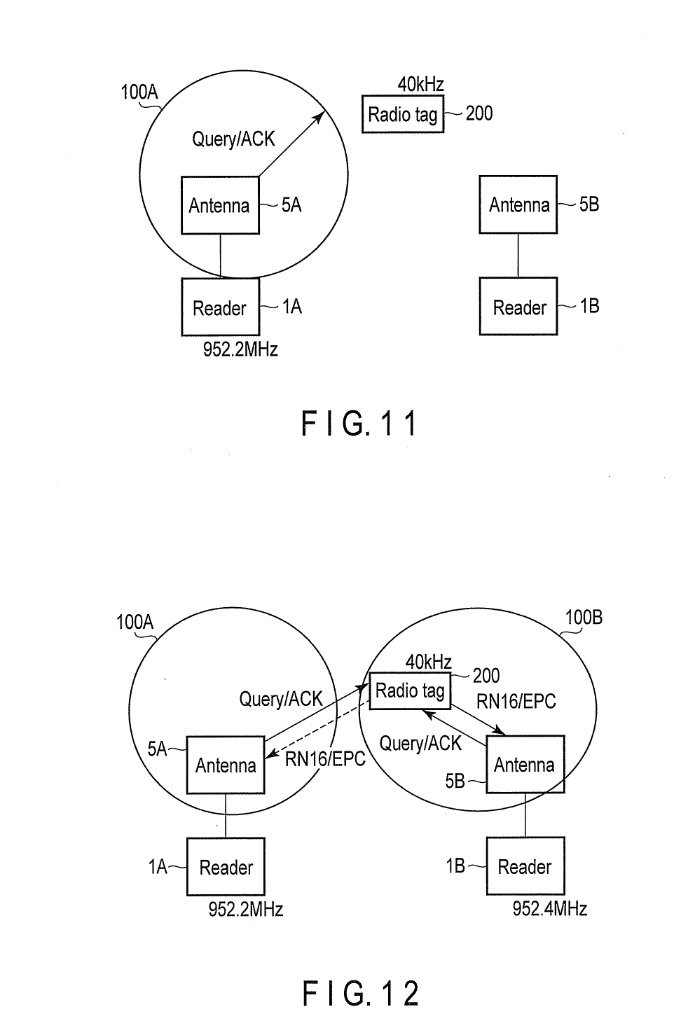

In an example explained below, as shown in FIGS. 11 and 12, two readers 1A and 1B are arranged close to each other. 100A in the figure indicates a range that a Query command and an ACK command transmitted from an antenna 5A of the reader 1A reach. 100B indicates a range that a Query command and an ACK command transmitted from an antenna 5B of the reader 1B reach. Arrangement positions and the like of the antennas 5A and 5B are adjusted such that the ranges 100A and 100B do not overlap. Frequency channels used by the readers 1A and 1B are set to frequency channels, center frequencies of which are respectively 952.2 MHz and 952.4 MHz. The RT cal is fixed at 75 μsec and the T pri is fixed at 25 μsec.

In FIG. 11, only the reader 1A operates. In this case, the Query command and the ACK command transmitted from the antenna 5A do not reach a radio tag 200 present outside the range 100A. Therefore, the reader 1A does not read the radio tag 200.

On the other hand, in FIG. 12, both the readers 1A and 1B operate. In this case, if the radio tag 200 is present within the range 100B, the Query command and the ACK command transmitted from the antenna 5B reach the radio tag 200. Therefore, the reader 1B can read the radio tag 200.

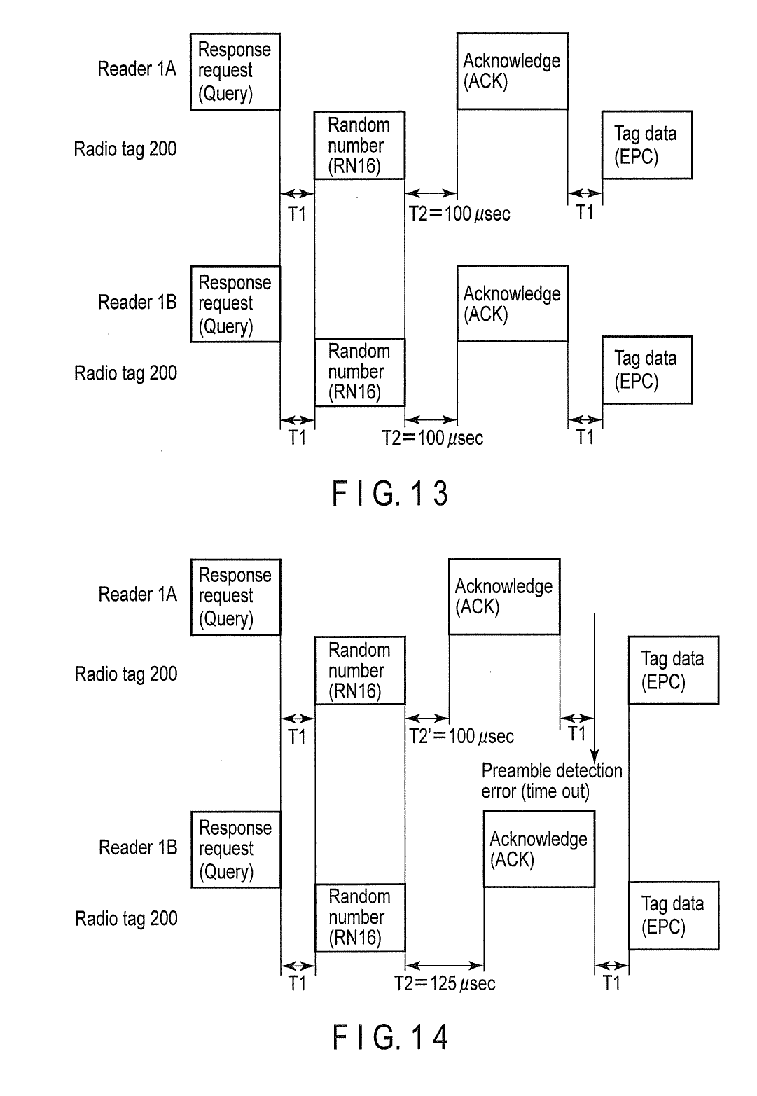

However, since an unmodulated carrier is transmitted with amplitude amplified to the maximum level as explained above, in some case, the unmodulated carrier from the reader 1A reaches the radio tag 200 in a state shown in FIG. 12. In this case, when the radio tag 200 receives a command from the reader 1B, the radio tag 200 subjects unmodulated carriers of both the readers 1A and 1B to the backscatter modulation and transmits a response signal of 952.2 MHz and a response signal of 952.4 MHz. At this point, if timing when the reader 1A outputs a bit of the Query command to a transmission system circuit of the reader 1A and timing when the reader 1B outputs a bit of the Query command to a transmission system circuit of the reader 1B accidentally coincide with each other as shown in FIG. 13, The RN16 (952.4 MHz) returned by the radio tag 200 can be received by the reader 1B. The RN16 (952.2 MHz) can be received by the reader 1A.

If the response times T2 are the same value 100 μsec in both the readers 1A and 1B, the readers 1A and 1B transmit ACK commands at a point when 100 μsec elapses after the readers 1A and 1B finish receiving the RN16. Only the ACK command transmitted from the reader 1B reaches the radio tag 200. When the radio tag 200 receives the ACK command from the reader 1B, the radio tag 200 subjects the unmodulated carriers of both the readers 1A and 1B to the backscatter modulation and returns tag data such as EPC. In this way, the tag data (952.4 MHz) returned by the radio tag 200 can be received by the reader 1B. The tag data (952.2 MHz) can also be received by the reader 1A. In other words, it is not unlikely that the radio tag 200 that should not originally be read by the reader 1A is read by the reader 1A.

On the other hand, in this embodiment, the response time T2 is variably set according to a frequency channel. Specifically, if the conversion table 13 shown in FIG. 9 is used, the response-time setting section 12 of the reader 1A sets the response time T2 of the reader 1A to 100 μsec and the response-time setting section 12 of the reader 1B sets the response time T2 of the reader 1B to 125 μsec. In this case, the reader 1A transmits the ACK command when 100 μsec elapses after the reader 1A finishes receiving the RN16. The reader 1B transmits the ACK command when 125 μsec elapses after the reader 1B finishes receiving the RN16. After finishing transmitting the ACK commands, the readers 1A and 1B perform operation for detecting a preamble of tag data returned from the radio tag 200 from the elapse of the comparison start time Ts indicated by Expression (4) until the elapse of the comparison end time Te indicated by Expression (5). At this point, in the reader 1B, a preamble of the tag data (952.4 MHz) returned by the radio tag 200 is normally detected.

However, in the reader 1A, the comparison start time Ts and the comparison end time Te come earlier than those in the reader 1B by 25 μsec. Specifically, before bit data of a preamble of the tag data (952.2 MHz) actually returned from the radio tag 200 finishes being stored in the shift register 331, the comparator 332 ends the detection of a preamble. Therefore, in the reader 1A, a preamble detection error occurs and the tag data from the radio tag 200 is not received.

In this way, in this embodiment, the response time T2 of the reader 1 is changed according to a frequency channel used by the reader 1. Usually, in view of the fact that frequency channels used by the plural readers 1 arranged adjacent to, one another are carrier-sensed not to overlap one another, it is possible to set the response times T2 of the readers 1 respectively to peculiar values by performing the operation as explained in this embodiment. As explained with reference to FIGS. 11 to 14, it is possible to prevent reading of the same radio tag by the plural readers 1.

### Modifications

The configurations disclosed in the embodiment can be variously modified and carried out. Examples of specific modifications are as explained below.
[1] In the embodiment, the reader 1 that communicates with the radio tag using the communication protocol of the C1G2 type is explained as the example. However, the configuration disclosed in the embodiment may be applied to a radio communication apparatus that communicates with a radio tag using a communication protocol other than C1G2. In this case, Expressions (1) to (9) only have to be changed according to an adopted communication protocol such that the peculiar response time T2 is set for each radio communication apparatus.
[2] In the configuration explained in the embodiment, the response-time setting section 12 and the conversion table 13 are provided independently from the controller 2. However, the response-time setting section 12 and the conversion table 13 may be provided in the controller 2.
[3] In the example explained in the embodiment, the response time T2 is set according to a frequency channel. However, the peculiar response time T2 may be set for each of the readers 1 using a parameter other than the frequency channel. In short, the peculiar response time T2 only has to be capable of being set for each of the plural readers 1 arranged adjacent to one another. Therefore, for example, a random number can be adopted as the parameter other than the frequency channel. Specifically, a random-number generating section that generates a random number is provided in the transmission system circuit, the reception system circuit, or the like of the reader 1. In the conversion table 13, the response time T2 is set in association with a numerical value that could be generated by the random-number generating section. The response-time setting section 12 is caused to acquire, from the conversion table 13, the response time T2 associated with a random number generated by the random-number generating section and set the acquired response time T2 as the response time T2 used by the reader 1. In this way, effects same as those in the embodiment can be obtained.
[4] When digital signal processing is performed during transmission of a command from the reader 1 or during reception of a response signal from the radio tag, if a delay time involved in the digital signal processing occurs, the response time T2 only has to be set taking into account the delay time.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A radio communication apparatus comprising:
a transmitting and receiving section configured to transmit an inquiry signal to a radio tag and receive a response signal returned from the radio tag;
a preamble detecting section configured to detect, within a period set with reference to transmission timing of the inquiry signal transmitted by the transmitting and receiving section, a preamble included in the response signal returned by the radio tag that receives the inquiry signal;
a data detecting section configured to detect, when the preamble detecting section detects the preamble included in the response signal, data following the preamble included in the response signal; and
a response-time setting section configured to set, according to a parameter peculiar to the apparatus, a response time from the reception of the response signal from the radio tag until transmission of a next inquiry signal to the radio tag by the transmitting and receiving section.

2. The apparatus of claim 1, wherein the response-time setting section selects one time corresponding to the parameter out of a plurality of times set at a discrete interval larger than the period and sets the selected time as the response time.

3. The apparatus of claim 2, further comprising a table in which the plurality of times are described at the discrete interval larger than the period, wherein the response-time setting section selects one time corresponding to the parameter out of the times described in the table and sets the selected time as the response time.

4. The apparatus of claim 1, wherein the period is a difference between a maximum and a minimum of a time from the reception of the inquiry signal until the transmission of the response signal by the radio tag.

5. The apparatus of claim 1, wherein the parameter is a frequency channel used by the transmitting and receiving section for communication with the radio tag.

6. The apparatus of claim 5, further comprising a frequency setting section configured to set the frequency channel on the basis of information input by operation of a predetermined operation section or information input from a host apparatus.

7. The apparatus of claim 1, wherein the parameter is a random number.

8. The apparatus of claim 1, wherein
the transmitting and receiving section transmits an inquiry signal encoded by a predetermined encoding system to the radio tag and receives a response signal encoded by the encoding system from the radio tag, and
when the preamble detecting section detects a preamble of the response signal, the data detecting section detects the data by decoding, according to the encoding system, a portion following the preamble included in the response signal.

9. The apparatus of claim 1, wherein the apparatus is an apparatus that communicates with the radio tag in a command sequence related to a communication protocol of a Class 1 Generation 2 type.

10. The apparatus of claim 9, wherein
the period is a difference between a maximum T1 max of a time T1 from the reception of the inquiry signal until the transmission of the response signal by the radio tag and a minimum T1 min of the time T1, and the maximum T1 max and the minimum T1 min are set by following calculation formulas:
T1 min=MAX(RT cal, 10T pri)×(1−FT)−2 μsec, and
T1 max=MAX(RT cal, 10T pri)×(1+FT)+2 μsec
using Interrogator-to-Tag calibration symbol RT cal, Backscatter-link pulse-repetition interval T pri, and Frequency variation FT in the communication protocol of the Class 1 Generation 2 type.

11. The apparatus of claim 9, wherein the response-time setting section sets the response time within a range of 3×T pri to 20×T pri indicated using Backscatter-link pulse-repetition interval T pri in the communication protocol of the Class 1 Generation 2 type.

12. The apparatus of claim 11, wherein the response-time setting section selects one time corresponding to the parameter out of a plurality of times set at a discrete interval larger than the period within the range indicated by 3×T pri to 20×T pri and sets the selected time as the response time.

13. The apparatus of claim 12, further comprising a table in which the plurality of times within the range of 3×T pri to 20×T pri are described at the discrete interval larger than the period, wherein
the response-time setting section selects one time corresponding to the parameter out of the times described in the table and sets the selected time as the response time.

14. The apparatus of claim 13, wherein
the apparatus includes a plurality of the tables corresponding to respective values of a plurality of the T pri, and
the response-time setting section selects one time corresponding to the parameter out of times described in the table corresponding to a value of the T pri currently used for communication with the radio tag among the tables and sets the selected time as the response time.

15. A radio communication method performed using a radio communication apparatus, comprising:
transmitting an inquiry signal to a radio tag and receiving a response signal returned from the radio tag;
detecting, within a period set with reference to transmission timing of the inquiry signal, a preamble included in the response signal returned by the radio tag that receives the inquiry signal;
detecting, when the preamble included in the response signal is detected, data following the preamble included in the response signal; and
setting, according to a parameter peculiar to the apparatus, a response time from the reception of the response signal from the radio tag until transmission of a next inquiry signal to the radio tag.

16. The method of claim 15, wherein the response time is set by selecting one time corresponding to the parameter out of a plurality of times set at a discrete interval larger than the period.

17. The method of claim 15, wherein the period is a difference between a maximum and a minimum of a time from the reception of the inquiry signal until the transmission of the response signal by the radio tag.

18. The method of claim 15, wherein the parameter is a frequency channel used by the radio communication apparatus for communication with the radio tag.

19. The method of claim 15, wherein
the radio communication apparatus is an apparatus that communicates with the radio tag in a command sequence related to a communication protocol of a Class 1 Generation 2 type,
the period is a difference between a maximum T1 max of a time T1 from the reception of the inquiry signal until the transmission of the response signal by the radio tag and a minimum T1 min of the time T1, and
the maximum T1 max and the minimum T1 min are set by following calculation formulas:
T1 min=MAX(RT cal, 10T pri)×(1−FT)−2 μsec, and
T1 max=MAX(RT cal, 10T pri)×(1+FT)+2 μsec
using Interrogator-to-Tag calibration symbol RT cal, Backscatter-link pulse-repetition interval T pri, and Frequency variation FT in the communication protocol of the Class 1 Generation 2 type.

20. The method of claim 15, wherein
the radio communication apparatus is an apparatus that communicates with the radio tag in a command sequence related to a communication protocol of a Class 1 Generation 2 type, and
the response time is set within a range of 3×T pri to 20×T pri indicated using Backscatter-link pulse-repetition interval T pri in the communication protocol of the Class 1 Generation 2 type.
